(19) United States
(12) Patent Application Publication
(10) Pub. No.: US 2026/0268200 A1
(43) Pub. Date: Sep. 10, 2026

(54) CLIFFORD-IN-MEMORY MODULAR FAULT-TOLERANT QUANTUM COMPUTING ARCHITECTURE

(71) Applicant: International Business Machines Corporation, Armonk, NY (US)

(72) Inventors: Andrew W. Cross, Yorktown Heights, NY (US); Michael Beverland, Seattle, WA (US); Emily Pritchett, Mt Kisco, NY (US); Patrick Julian Tassilo Rall, Boston, MA (US); Eddie Schoute, Cambridge, MA (US); Theodore James Yoder, Mohegan Lake, NY (US)

(21) Appl. No.: 19/073,729

(22) Filed: Mar. 7, 2025

(51) Int. Cl. G06N 10/70; G06N 10/20; G06N 10/40

(52) U.S. Cl. CPC G06N 10/70; G06N 10/20; G06N 10/40

(57) ABSTRACT

One or more systems, devices, computer program products and/or computer-implemented methods of use provided herein relate to modular fault-tolerant quantum computing. For example, a system can comprise a memory that can store computer executable components and a processor that can execute the computer executable components stored in the memory. The computer executable components can comprise an operation component that performs, on a quantum processor, stabilizer operations on logical qubits encoded in a quantum error correction code. The computer executable components can further comprise an execution component that performs, on the quantum processor, universal quantum operations on the logical qubits using the stabilizer operations, wherein the stabilizer operations consume magic state.

### BACKGROUND

The subject disclosure relates to quantum computing, and more specifically, to a Clifford-in-memory modular fault-tolerant quantum computing architecture.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable Clifford-in-memory modular fault-tolerant quantum computing are discussed.

According to an embodiment, a system is provided. The system can comprise a memory that can store computer executable components. The system can further comprise a processor that can execute the computer executable components stored in the memory, where the computer executable components can comprise an operation component that performs, on a quantum processor, stabilizer operations on logical qubits encoded in a quantum error correction code. The computer executable components can further comprise an execution component that performs, on the quantum processor, universal quantum operations on the logical qubits using the stabilizer operations, wherein the stabilizer operations consume magic state.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate Clifford-in-memory (CIM) modular fault-tolerant quantum computing in accordance with one or more embodiments described herein.

FIG. 2 illustrates another block diagram of an example, non-limiting system that can facilitate Clifford-in-memory modular fault-tolerant quantum computing in accordance with one or more embodiments described herein.

FIG. 3 illustrates an example, non-limiting diagram of a CIM module coupled to a magic state factory module in accordance with one or more embodiments described herein.

FIG. 4 illustrates an example, non-limiting diagram of a plurality of CIM modules coupled to a magic state factory module in accordance with one or more embodiments described herein.

FIG. 5 illustrates an example, non-limiting diagram showing coupling using Bell couplers in accordance with one or more embodiments described herein.

FIG. 6 illustrates an example, non-limiting diagram showing shift automorphism on an error correction code in accordance with one or more embodiments described herein.

FIG. 7 illustrates an example, non-limiting diagram showing how global Pauli rotations can be implemented in accordance with one or more embodiments described herein.

FIG. 8 illustrates an example, non-limiting diagram showing Greenberger-Horne-Zeilinger state preparation across CIM modules in accordance with one or more embodiments described herein.

FIG. 9 illustrates an example, non-limiting diagram showing how native Pauli measurements and native Pauli rotations can be implemented in accordance with one or more embodiments described herein.

FIG. 10 illustrates an example, non-limiting diagram showing how general Pauli measurements can be implemented in accordance with one or more embodiments described herein.

FIG. 11 illustrates an example, non-limiting diagram showing how small-angle rotations can be implemented in accordance with one or more embodiments described herein.

FIG. 12 illustrates an example, non-limiting diagram showing how non-Clifford phase rotations can be implemented in accordance with one or more embodiments described herein.

FIG. 13 illustrates a flow diagram of an example, non-limiting method 1400 that embodiments described herein.

FIG. 14 illustrates a flow diagram of an example, non-limiting method 1400 that can facilitate CIM modular fault-tolerant quantum computing in accordance with one or more embodiments described herein.

FIG. 15 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment, a system is provided. The system can comprise a memory that can store computer executable components. The system can further comprise a processor that can execute the computer executable components stored in the memory, where the computer executable components can comprise an operation component that performs, on a quantum processor, stabilizer operations on logical qubits encoded in a quantum error correction code. The computer executable components can further comprise an execution component that performs, on the quantum processor, universal quantum operations on the logical qubits using the stabilizer operations, wherein the stabilizer operations consume magic state.

Such embodiments of the system can provide a number of advantages, including reducing the number of physical qubits needed for scalable fault-tolerant quantum computing, improving efficiency of fault-tolerant quantum computing by enabling stabilizer operations in high-rate quantum error correction codes, reducing overhead of fault-tolerant quantum computing, and enabling modularity of fault-tolerant quantum computing architectures.

In one or more embodiments of the aforementioned system, the quantum error correction code can be a high-rate quantum low-density parity-check (qLDPC) code. Such embodiments of the system can provide the advantage improving efficiency of fault-tolerant quantum computing by enabling logical operations to be performed in high-rate quantum error correction codes.

In one or more embodiments of the aforementioned system, the operation component can perform the stabilizer operations via one or more Clifford-in-memory (CIM) modules, and wherein the one or more CIM modules comprise a respective memory and a respective logical processing unit (LPU). Such embodiments of the system can provide the advantage of improving efficiency of fault-tolerant quantum computing by enabling logical operations to be performed in high-rate quantum error correction codes.

In one or more embodiments of the aforementioned system, the computer executable components can further comprise a generation component that can generate, via one or more magic state factory modules, the magic states using the quantum error correction code or a secondary quantum error correction code. Such embodiments of the system can provide a number of advantages, including improving efficiency of fault-tolerant quantum computing by enabling logical operations to be performed in high-rate quantum error correction codes.

In one or more embodiments of the aforementioned system, the computer executable components can further comprise a coupling component that couples the one or more CIM modules to each other. In one or more embodiments of the aforementioned system, the coupling component can couple the one or more CIM modules to the one or more magic state factory modules. Such embodiments of the system can provide the advantage of enabling modular fault-tolerant quantum system.

In one or more embodiments of the aforementioned system, the operation component can allocate one or more pivot qubits in the respective memory of any of the one or more CIM modules. Such embodiments of the system can provide a number of advantages, including enabling universal quantum operations in a scalable fault-tolerant quantum computer by enabling injection of magic states into stabilizer operations, and improving efficiency of fault-tolerant quantum computing by enabling stabilizer operations in high-rate quantum error correction codes.

In one or more embodiments of the aforementioned system, the coupling component can connect the respective LPUs to each other through a set of bridge qubits and a set of bridge checks in the respective LPUs that are connected to the quantum error correction code. Such embodiments of the system can provide a number of advantages, including enabling modular fault-tolerant quantum system.

In one or more embodiments of the aforementioned system, the operation component can perform the stabilizer operations using generalized qLDPC surgery. Such embodiments of the system can provide a number of advantages, including limiting the number of qubits required for scalable fault-tolerant quantum computing with qLDPC codes.

In one or more embodiments of the aforementioned system, Bell couplers can create physical entangled states between physical qubits in the quantum processor to implement the set of bridge qubits and the set of bridge checks. Such embodiments of the system can provide a number of advantages, including enabling modular fault-tolerant quantum system.

In one or more embodiments of the aforementioned system, the coupling component can use coupling between the one or more CIM modules to prepare Greenberger Horne Zeilinger (GHZ) states. Such embodiments of the system can provide a number of advantages, including providing flexible modularity of the fault-tolerant quantum system by enabling entanglement across the one or more CIM modules.

According to various embodiments, the above-described system can be implemented as a computer-implemented method or as a computer program product.

### Definitions

Computer architecture: Computer architecture is a description of the structure of a computer system in terms of its components. The complete description of an architecture includes the instruction set architecture, microarchitecture, and system design.

Fault-tolerance: Fault-tolerance is a design property that allows a system to accurately process information despite unreliable components. The components of a fault-tolerant system are designed such that errors propagate in a controlled way and are periodically detected and corrected. In this way, reliable systems can be built from unreliable parts.

Quantum low-density parity-check (qLDPC) code: A qLDPC code is a quantum error correcting code whose check measurements involve a bounded number of qubits and whose qubits are involved in a bounded number of checks.

Clifford gates: Clifford gates are a subgroup of quantum gates generated by CNOT, Hadamard, and Phase gates. They are not universal gates on their own.

Stabilizer operations: Stabilizer operations are the set of operations composed from stabilizer state initialization, Pauli measurements, Clifford gates, and classical control.

Surface code architecture: Surface code architecture is a fault-tolerant quantum computing architecture based on a vast array of nearest-neighbor connected qubits encoded into large surface code patches. Gates are applied by a combination of lattice surgery and magic state preparation.

Lattice surgery: Lattice surgery is a technique for measuring logical Pauli operators of surface codes using only geometrically local physical measurements.

Magic state preparation: Magic state preparation a process that yields a low-error resource state.

Magic state factory module: A Magic state factory module is a unit that produces sequences of low-error magic states for consumption by the rest of the quantum computer.

Clifford-in-memory (CIM): A CIM is our name for the concept of applying stabilizer operations directly to logical qubits encoded in efficient qLDPC codes, as opposed to first transferring those qubits to a computing module that may use inefficient codes.

Pauli-based computing (PBC): A PBC is a computing model whose operations are logical Pauli measurements, magic state preparations, and classical control.

Logical processing unit (LPU): An LPU is a collection of auxiliary qubits attached to a code block to enable stabilizer operations on the code block.

l-coupler: An l-coupler is a long-range cryogenic microwave coupler to enable gates between distant qubits

Bell coupler: A bell coupler is an l-coupler that enables remote Bell state preparation. A Bell state is a maximally entangled state of two qubits.

Greenberger-Horne-Zeilinger (GHZ) state: A GHZ state is a Greenberger-Horne-Zeilinger entangled state of n-qubits, having a form of |00 . . . 0>+|11 . . . 1>.

In quantum computing, quantum information is inherently fragile and highly susceptible to noise, making it difficult to manipulate accurately. As quantum circuits increase in depth, the accumulation of errors leads to unreliable computational results. Consequently, achieving scalable quantum systems necessitates some level of fault tolerance. Fault tolerance is implemented by encoding physical qubits into quantum error correction codes, forming logical qubits, and processing the encoded information. However, because logical qubits are encoded into groups of physical qubits, fault-tolerant approaches introduce significant resource overhead in terms of both storage and computational time, posing a major challenge for scalability.

Existing schemes for fault-tolerant quantum computing, such as the surface code architecture, use only nearest neighbor gates and has an accuracy threshold of about 0.7%. While this accuracy threshold enables fault-tolerant computation, the surface code architecture suffers from poor resource efficiency. Specifically, the encoding rate diminishes at large scales, requiring an extensive number of physical qubits. Typically, it is in the range of hundreds to thousands of physical qubits per logical qubit. This inefficiency drastically limits the feasibility of large-scale quantum computations and increases hardware complexity.

Other existing methods leverage more efficient quantum error correction codes, such as high-rate qLDPC codes, which can achieve higher accuracy thresholds. These quantum error correction codes can offer improved encoding efficiency, however, performing fault-tolerant logical operations using such codes presents significant challenges. Particularly, when using more efficient quantum error correction codes, implementing computational gates on error-corrected qubits is complex, often requiring intricate operations that can introduce additional errors or require substantial additional resources.

Furthermore, another limitation of existing methods is that they primarily utilize efficient quantum error correction codes for only memory storage while performing computational operations on separate, less efficient error correction codes. Specifically, in these approaches, information is stored in the memory using a high-rate quantum error correction code, then moved into a less efficient quantum error correction code that is easier to compute with. Thereafter, computations are performed in the less efficient quantum error correction code, and the information is subsequently moved back into the memory. This memory-centric approach limits the overall benefits of high-rate quantum error correction codes, as logical operations remain constrained by inefficient quantum error correction codes. As a result, these existing methods struggle to achieve sufficient reductions in the total number of physical qubits required for fault-tolerant quantum computing and thus limiting scalability.

Thus, methods and techniques that can achieve scalable fault-tolerant quantum computing that is universal, provides reduced overhead (e.g., using less physical qubits), and is modular are desirable.

Various embodiments of the present disclosure can be implemented to produce a solution to these problems. Embodiments described herein include systems, computer-implemented methods, and computer program products that provide a method to enable modular, universal fault-tolerant quantum computing through one or more CIM modules. In particular, various embodiments described herein can couple one or more CIM modules to one or more magic state factory modules. By coupling the one or more CIM modules and the one or more magic state factory modules, the various described herein can enable a modular architecture for scalable fault-tolerant quantum computing.

In various aspects, the one or more magic state factory modules can generate magic states. Thereafter, various embodiments described herein can perform, on a quantum system, stabilizer operations on logical qubits encoded in a quantum error correction code. In various instances, the quantum error correction code can be any suitable, efficient quantum error corection code, such as a high-rate qLDPC code. Thus, various embodiments described herein can perform, on the quantum system, universal quantum operations on the logical qubits by using the stabilizer operations, where the stabilizer operations can consume the magic states. In other words, the various embodiments described herein can perform logical operations using the efficient quantum error correction code to enable universal quantum operations by performing stabilizer operations that can consume the magic states. Accordingly, the number of physical qubits required can be significantly reduced, thus reducing overhead and associated overhead costs. That is, the various embodiments described herein can provide a more efficient and modular architecture to facilitate scalable fault-tolerant quantum computing that is reliable and can reduce overhead.

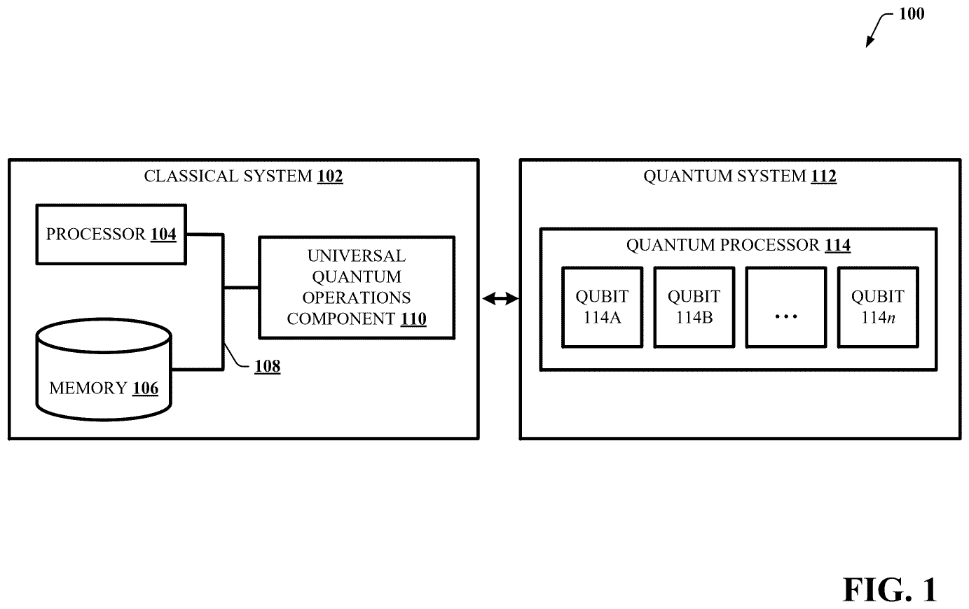

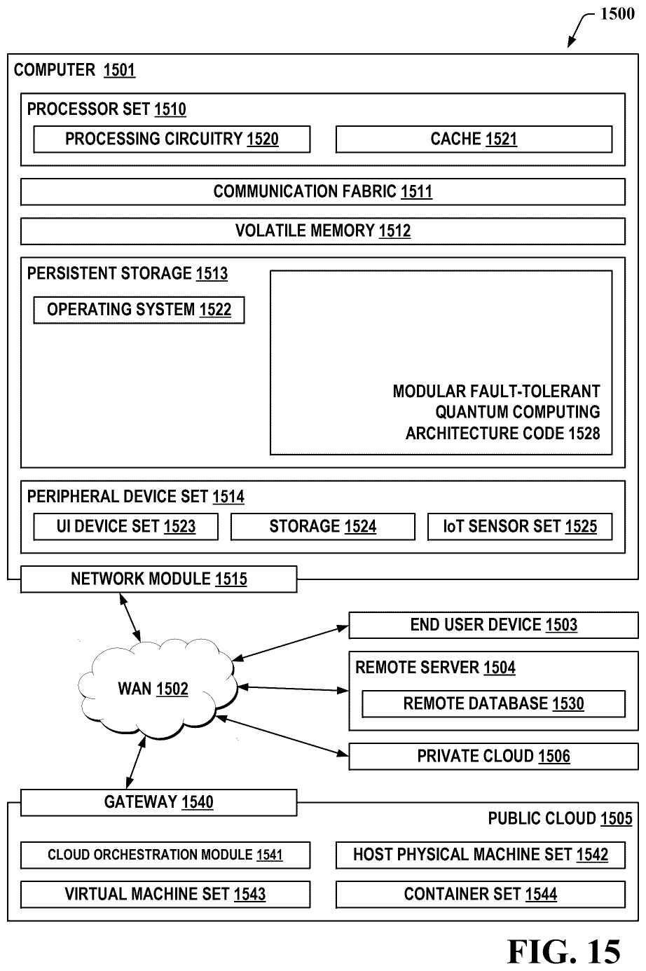

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1500 illustrated at FIG. 15. For example, non-limiting system 100 can be associated with, such as accessible via, a computing environment 1500 described below with reference to FIG. 15, such that aspects of processing can be distributed between non-limiting system 100 and the computing environment 1500. In one or more described embodiments, computer and/or computing-based elements can be used in connection with implementing one or more of the systems, devices, components and/or computer-implemented operations shown and/or described in connection with FIG. 1 and/or with other figures described herein.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 1 illustrates a block diagram of an example, non-limiting system 100 that embodiments described herein.

Non-limiting system 100 and/or the components of non-limiting system 100 can be employed to use hardware and/or software to solve problems that are highly technical in nature (e.g., related to fault-tolerant quantum computing, quantum error correction, quantum computing architectures, etc.), that are not abstract and that cannot be performed as a set of mental acts by a human. Further, some of the processes performed may be performed by specialized computers for carrying out defined tasks related to CIM modular fault-tolerant quantum computing. Non-limiting system 100 and/or components of non-limiting system 100 can be employed to solve new problems that arise through advancements in technologies mentioned above, computer architecture, and/or the like. Non-limiting system 100 can provide technical improvements to quantum computing systems by reducing the overhead involved in fault-tolerant quantum computing by reducing the number of physical qubits required for encoding logical qubits, enabling a modular architecture for quantum computing, enabling universal quantum operations with reduced overhead, improving efficiency of fault-tolerant quantum computing by performing logical operations on efficient quantum error correction codes, etc.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., universal quantum operations component 110, operation component 202, execution component 204, generation component 206, and/or coupling component 208) to perform one or more actions. In one or more embodiments, memory 106 can store computer-executable components (e.g., universal quantum operations component 110, operation component 202, execution component 204, generation component 206, and/or coupling component 208).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

As illustrated in FIG. 1, non-limiting system 100 can comprise classical system 102 and quantum system 112. Classical system 102 can be coupled (operatively, communicatively, electrically, and/or like function) to quantum system 112. Quantum system 112 can comprise at least one quantum processor, such as quantum processor 114. Classical system 102 can comprise one or more components, such as a memory 106, processor 104, bus 108, and/or universal quantum operations component 110. In an embodiment, universal quantum operations component 110 can be comprised at least partially by quantum system 112. Quantum processor 114 can comprise one or more qubits 114, such as qubit 114A, qubit 114B, . . . , qubit 114n, etc., where n represents a positive integer. Quantum processor 114 can be any suitable processor.

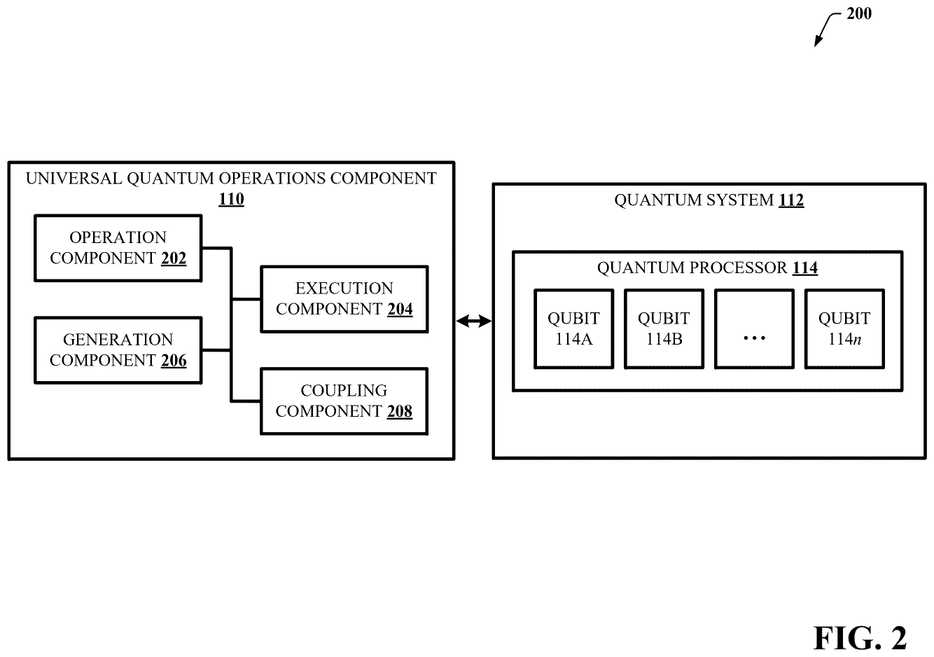

In various embodiments, universal quantum operations component 110 can comprise operation component 202, execution component 204, generation component 206, and coupling component 208, as illustrated in FIG. 2.

In various embodiments, operation component 202 can perform, on quantum system 112, as described herein, stabilizer operations on logical qubits encoded in a quantum error correction code. In various aspects, operation component 202 can perform the stabilizer operations via one or more CIM modules (e.g., CIM module 306). In various embodiments, each of the one or more CIM modules can comprise a logical processing unit (LPU) and a respective memory.

In various embodiments, generation component 206 can generate, via one or more magic state factories (e.g., magic state factory module 308), magic states. In various aspects, the stabilizer operations can consume the magic states. Accordingly, in various embodiments, execution component 204 can perform, on quantum system 112, as described herein, universal quantum operations on the logical qubits using the stabilizer operations that can consume the magic states.

To achieve this, coupling component 208 can, as described herein, couple the one or more CIM modules to each other. In various embodiments, coupling component 208 can couple the one or more CIM modules to each other by connecting the LPU of each of the one or more CIM modules. More specifically, coupling component 208 can connect an LPU of a first CIM module to the LPU of a second CIM module. In various instances, such connection of LPUs can be facilitated by Bell couplers that create physical entanglement between physical qubits (e.g., between qubits 114). Further, in various aspects, coupling component 208 can couple the one or more magic state factory modules to the one or more CIM modules.

In various embodiments, coupling component 208 can create entanglement between the one or more CIM modules. In various instances, coupling component 208 can create the entanglement between the one or more CIM modules using any suitable methods. For instance, coupling component 208 can entangle the one or more CIM modules using 1-couplers, such as Bell couplers. In particular, by using Bell couplers, coupling component 208 can create entanglement between physical qubits in the one or more CIM modules.

FIG. 2 illustrates a block diagram of an example, non-limiting system 200 that can facilitate CIM modular fault-tolerant quantum computing in accordance with one or more embodiments described herein. Repetitive description of like elements and/or processes employed in respective embodiments is omitted for sake of brevity.

As described with reference to FIG. 1, universal quantum operations component 110 can comprise operation component 202, execution component 204, generation component 206, and coupling component 208. In this regard, non-limiting system 200 describes the classical system 102 of universal quantum operations component 110 and quantum system 112 that can facilitate modular and scalable fault-tolerant quantum computing.

In various embodiments, operation component 202 can perform, on quantum system 112, stabilizer operations on logical qubits encoded in a quantum error correction code. For instance, stabilizer operations can include any suitable operations composed of stabilizer state initialization, Pauli measurements, Clifford gates (e.g., Hadamard (H) gates, Phase(S) gates, Controlled-NOT (CNOT) gates), or classical control (e.g., classical feedforward operations). In various aspects, operation component 202 can perform the stabilizer operations via the one or more CIM modules.

In various instances, operation component 202 can perform the stabilizer operations using any suitable method or technique. As a non-limiting example, if the quantum error correction code is a qLDPC code, operation component 202 can perform the stabilizer operations using generalized qLDPC surgery. Generalized qLDPC surgery is a technique for performing fault-tolerant quantum operations on generalized qLDPC codes by merging and splitting logical qubits. Applying generalized qLDPC surgery in particular can limit the number of physical qubits required while maintaining an acceptable logical failure probability for the logical qubits, thus reducing overhead while providing reliable results.

In various aspects, to enable the universal quantum operations, the stabilizer operations can consume the magic states. A magic state is a quantum state that can be used as a resource in order to implement a non-stabilizer gate.

In quantum computing, non-Clifford gates are necessary to implement general, universal quantum computations. That is, stabilizer operations are not sufficient alone to enable universal computation (e.g., universal quantum operations). Accordingly, the stabilizer operations can consume the magic states to apply non-Clifford gates and thus enable universal quantum operations. In other words, the stabilizer operations can use the magic states to enable implementation of a non-Clifford operation on a stabilizer state. For instance, a stabilizer circuit and a T-gate can enable universal computation.

In various embodiments, the one or more magic state factories can generate a magic state via the one or more magic state factories by applying a series of quantum operations designed to prepare specific non-stabilizer states. As a non-limiting example, generation component 206 can generate a T-state, which is a magic state used to implement the T-gate (π/8 gate). As another non-limiting example, generation component 206 can generate an S-state, which is a magic state used to implement the S-gate (phase gate). As still another non-limiting example, generation component 206 can generate an H-state, which is a magic state used to implement the Hadamard gate. As even another non-limiting example, generation component 206 can generate π/8 rotation states, which are magic states used for implementing a range of gates, including higher-order non-Clifford gates.

In various embodiments, the stabilizer operations can consume the magic state through magic state injection (e.g., a process involving using a magic state to perform a non stabilizer gate), which only involves stabilizer operations. In various instances, generation component 206 can generate a plurality of magic states, which can be injected using stabilizer operations via magic state injection. For instance, generation component 206 can use the magic states to generate a T-gate via magic state injection.

In various instances, generation component 206 can generate the magic states using the quantum error correction code 304. In other instances, generation component 206 can generate the magic states using a secondary quantum error correction code (e.g., a less efficient but less computationally demanding quantum error correction code).

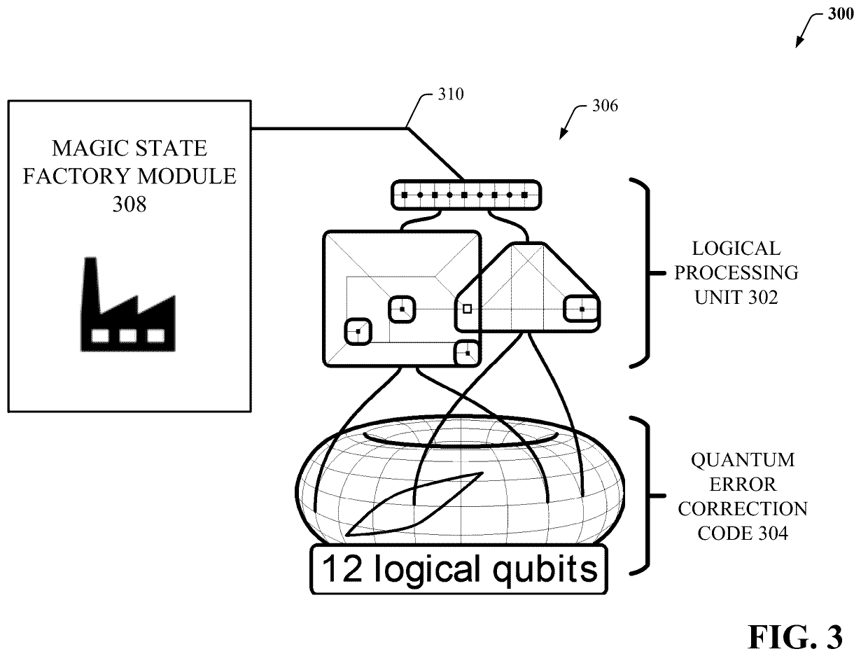

FIG. 3 illustrates an example, non-limiting diagram 300 of a CIM module coupled to a magic state factory module in accordance with one or more embodiments described herein.

In various aspects, CIP module 306 can comprise an LPU 302 that consists of a collection of auxiliary qubits (e.g., LPU 302 can comprise 90 physical qubits).

In various embodiments, a CIP module 306 can comprise a memory. More specifically, a quantum error correction code 304 can function as the memory of the CIM module 306. In various cases, quantum error correction code 304 can be any suitable efficient quantum error correction code, such a high-rate qLDPC code. In the non-limiting examples of FIGS. 3-12, the quantum error correction code 304 is a bivariate bicycle (BB) code of 288 physical qubits. Note that, this is a non-limiting example and that the various embodiments described herein can apply to any quantum error correction code, such as qLDPC codes (e.g., gross code, two-gross code) or non-qLDPC codes. In any case, CIP module 306 can enable logical operations to be performed in memory using a high-rate (e.g., or otherwise more efficient) quantum error correction code, as opposed to existing methods that only use the high-rate quantum error correction code as memory and perform logical operations outside of the memory (e.g., typically on less efficient quantum error correction codes). Thus, the various embodiments described herein can provide more efficient and scalable fault-tolerant quantum computing compared to existing methods.

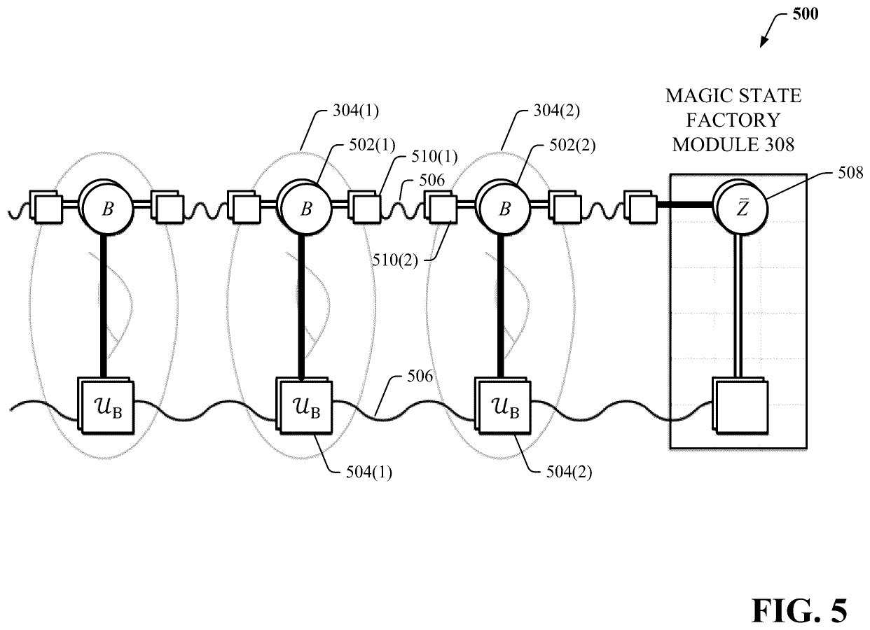

In various embodiments, coupling component 208 can couple a magic state factory module 308 to the CIP module 306 via a universal adapter 310. In various aspects, the universal adapter 310 can be implemented with l-couplers (e.g., long-range microwave couplers). In particular, coupling component 208 can couple magic state factory module 308 to CIP module 306 using Bell couplers. Various non-limiting aspects are described with respect to FIG. 5.

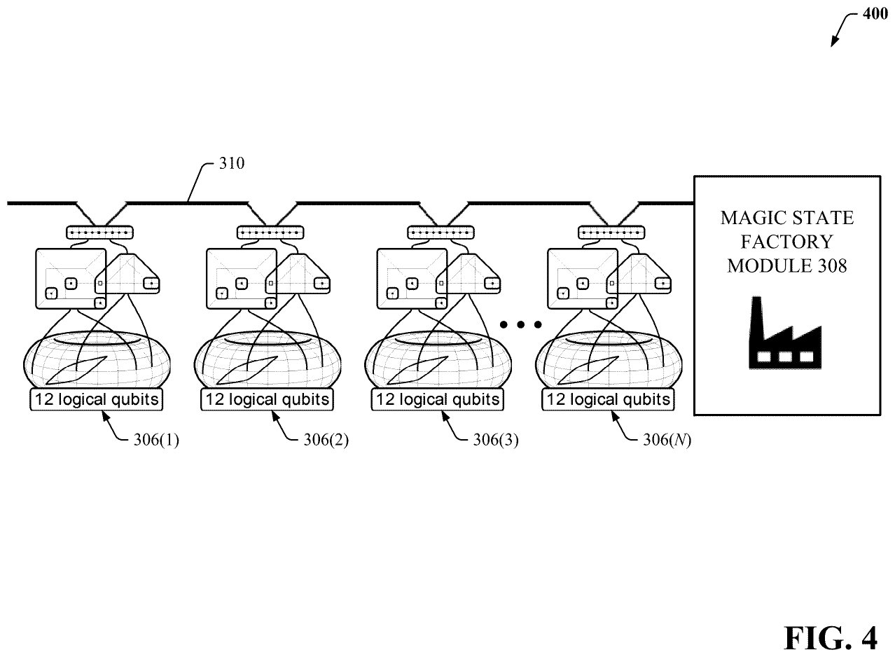

FIG. 4 illustrates an example, non-limiting diagram 400 of a plurality of CIM modules coupled to a magic state factory module in accordance with one or more embodiments described herein.

As used herein, “one or more of the CIM module 306” is referred to herein as “one or more CIM modules 306”. In various aspects, the one or more CIM modules 306 can comprise any positive integer n of CIM modules: a CIM module 306(1) to a CIM module 306(n). In various embodiments, coupling component 208 can couple two CIM modules via universal adapter 310. For example, as shown, coupling component 208 can couple CIM module 306(1) to CIM module 306(2) via universal adapter 310. Similarly, coupling component 208 can couple a CIM module to a magic state factory via universal adapter 310. For instance, as shown, coupling component 208 can couple CIM module 306(n) to magic state factory module 308 via universal adapter 310.

In various embodiments, coupling component 208 can use the coupling between the one or more CIM modules 306 to prepare GHZ states. The GHZ states can create logical entanglement between the logical qubits in quantum error correction code 304. That is, by preparing GHZ states using the coupling between the one or more CIM modules 306, entanglement can be distributed among the quantum system 112. This can thus enable flexible modularity. That is, the distributed entanglement among the one or more CIM modules 306 enabled by the GHZ states can allow the one or more CIM modules 306 to be coupled arbitrarily.

Note that, although FIG. 4 only depicts one magic state factory module to be coupled, any suitable number of magic state factory modules can be coupled to the one or more CIM modules 306.

Also note that, although FIG. 4 depicts the one or more CIM modules 306 and magic state factory module 308 coupled in a linear line, the one or more CIM modules 306 and magic state factory module 308 (or multiple magic state factory modules) can be coupled in any suitable geometric arrangement or configuration (e.g., a grid, circular, or another topology).

FIG. 5 illustrates an example, non-limiting diagram 500 showing coupling using Bell couplers in accordance with one or more embodiments described herein.

In various embodiments, coupling component 208 can couple LPUs of two CIM modules through a set of bridge qubits and a set of bridge checks in the LPUs 302 of the two CIM modules. For instance, there can be a first CIM module 306(1) and a second CIM module 306(2). In various aspects, coupling component 208 can couple the LPU 302 of the first CIM module 306(1) to the LPU 302 of the second CIM module 306(2).

More specifically, the LPU 302 of the first CIM module 306(1) can consist of a set of bridge qubits 502(1) and a set of bridge checks 510(1). Similarly, the LPU 302 of the second CIM module 306(2) can consist of a set of bridge qubits 502(2) and a set of bridge checks 510(2). In various aspects, coupling component 208 can entangle the set of bridge qubits 502(1) and the set of bridge checks 510(1) to the set of bridge qubits 502(2) and the set of bridge checks 510(2).

In various embodiments, coupling component 208 implement such entanglement using Bell couplers 506. That is, the Bell couplers 506 can create physical entangled states between physical qubits in the quantum processor 114. In other words, the Bell couplers 506 can be sufficient to implement the set of bridge qubits and the set of bridge checks in the one or more CIM modules 306.

Similarly, coupling component 208 can entangle the set of bridge qubits 502(1) and the set of bridge checks 510(1) of the LPU 302 with a set of qubits 508 and its adjacent checks in magic state factory module 308 using Bell couplers.

In various aspects, the Bell couplers can enable logical measurements to be performed between different modules of the one or more CIM modules 306. Furthermore, the Bell couplers can enable the stabilizer operations to consume a magic state from magic state factory module 308, thus enabling universal quantum operations to be performed.

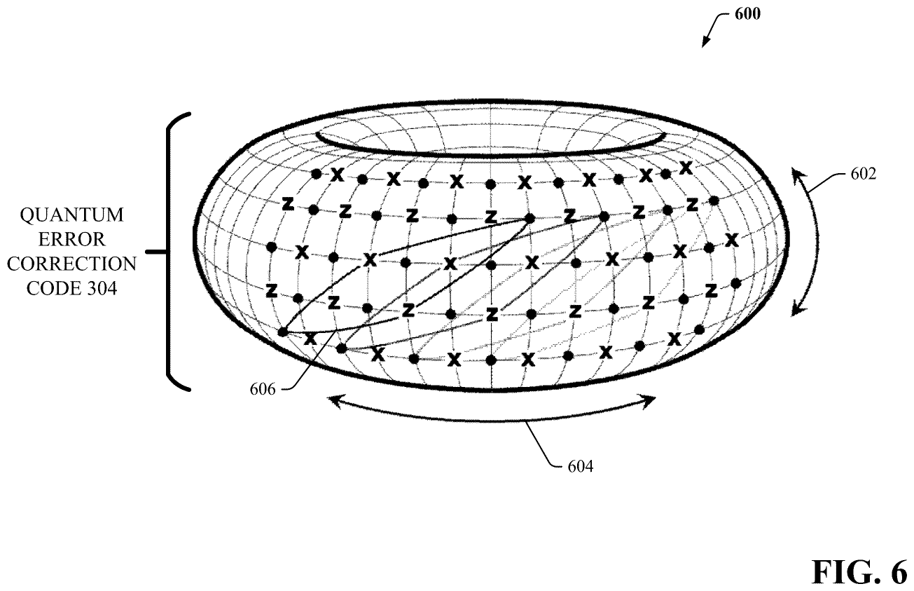

FIG. 6 illustrates an example, non-limiting diagram 600 showing shift automorphism on an error correction code in accordance with one or more embodiments described herein.

In various embodiments, the LPU 302 can enable logical operations on the quantum error correction code 304. Specifically, the LPU 302 can enable stabilizer operations on a single code block. As a non-limiting example, as shown in FIG. 3, 12 logical qubits can be encoded in quantum error correction code 304, 1 of which is a readout qubit. In various aspects, LPU 302 can allow for measuring values of one or more of the 12 logical qubits. However, this is not sufficient to perform all stabilizer operations. Accordingly, operation component 202 can perform automorphisms to perform stabilizer operations not supported by the LPU 302.

Non-limiting diagram 600 depicts an example representation of shift automorphisms on quantum error correction code 304. As shown, long-range connections within the quantum error correction code 304 can be denoted by 606. Automorphisms can leverage symmetries within quantum error correction code 304 to shift the physical qubits around data stored in the logical qubits. For instance, to perform stabilizer operations not supported by LPU 302, operation component 202 can perform an automorphism. In the non-limiting example of FIG. 6 where quantum error correction code 304 is a BB code, operation component 202 can shift the physical qubits using radial shifts 602 that move physical qubits from an outer ring toward a center of the BB code. In other cases, operation component 202 can shift the physical qubits using tangential shifts 604 that move physical qubits along the surface of the BB code in a horizontal direction.

In any case, operation component 202 can perform automorphisms to provide stabilizer operations that are not supported by the LPU 302. Therefore, by using stabilizer operations supported by the LPU 302 and stabilizer operations provided by applying automorphisms, operation component 202 can synthesize any Clifford operation.

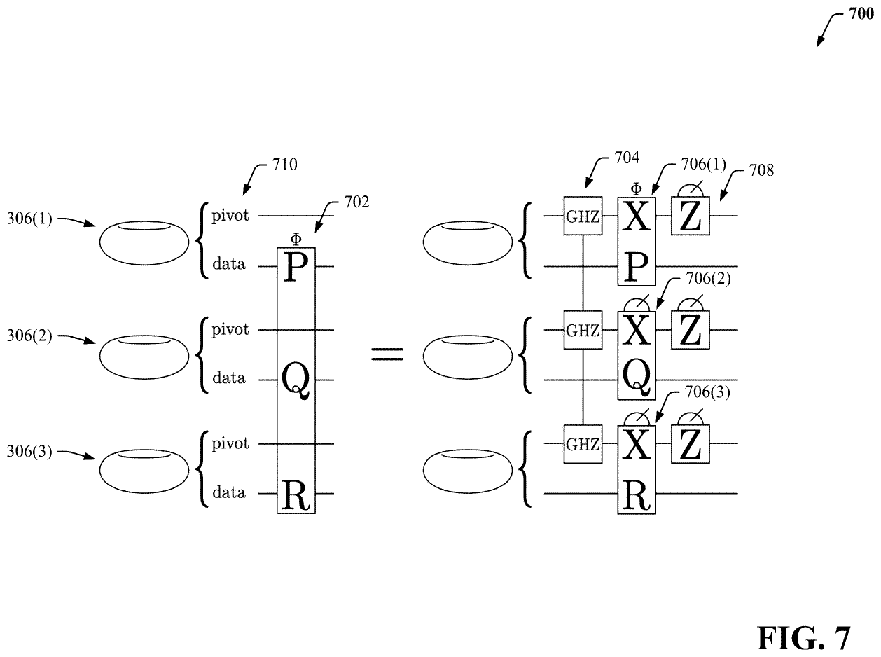

FIG. 7 illustrates an example, non-limiting diagram 700 showing how global Pauli rotations can be implemented in accordance with one or more embodiments described herein.

In various embodiments, execution component 204 can perform global Pauli rotations using the stabilizer operations and magic states. A Pauli rotation acts on all data within a quantum system. To achieve this in various aspects, execution component 204 can perform a Pauli rotation by using Pauli rotation 702, which specifies a rotation along each rotation axis for each logical qubit.

To implement the Pauli rotation 702 across two or more CIM modules (e.g., to implement a global Pauli rotation), execution component 204 can implement global Pauli rotations at an angle φ using distributed GHZ state preparation 704, module-local Pauli rotations and measurements (e.g., a non-Clifford phase rotation 706(1) by angle φ, a non-Clifford measurement 706(2), and a non-Clifford measurement 706(3)) using the magic state factory module 308, and a Z-measurement on the pivot qubit 710.

More specifically, coupling component 208 can first prepare a GHZ state across the one or more CIM modules 306 (e.g., for each of the one or more CIM modules 306, for any two or more CIM modules 306). In various aspects, coupling component 208 can prepare the GHZ states on pivot qubits 710. To facilitate this, operation component 202 can allocate one or more pivot qubits in the memory of each of the one or more CIM modules 306. This means data cannot be stored on the one or more pivot qubits. In various aspects, the one or more pivot qubits can act as scratch space that can be reused to implement various quantum operations using the stabilizer operations and magic states.

Furthermore, applying module-local Pauli rotations 706(1) can involve applying a Pauli measurement at angle φ at a particular rotation angle locally. This means that on CIM module 306(1), for example, operation component 202 can apply a Pauli rotation around XP with angle φ.). Moreover, applying module-local Pauli measurements (e.g., measurement 706(2) and measurement 706(3) can involve applying a Pauli measurement locally. Accordingly, operation component 202 can, for example, apply a Pauli measurement of XQ on CIM module 306(2), and a Pauli measurement of XR of CIM module 306(3).

Following the module-local Pauli measurements 706, operation component 202 can apply a Z-measurement on the pivot qubit 704 of each CIM module.

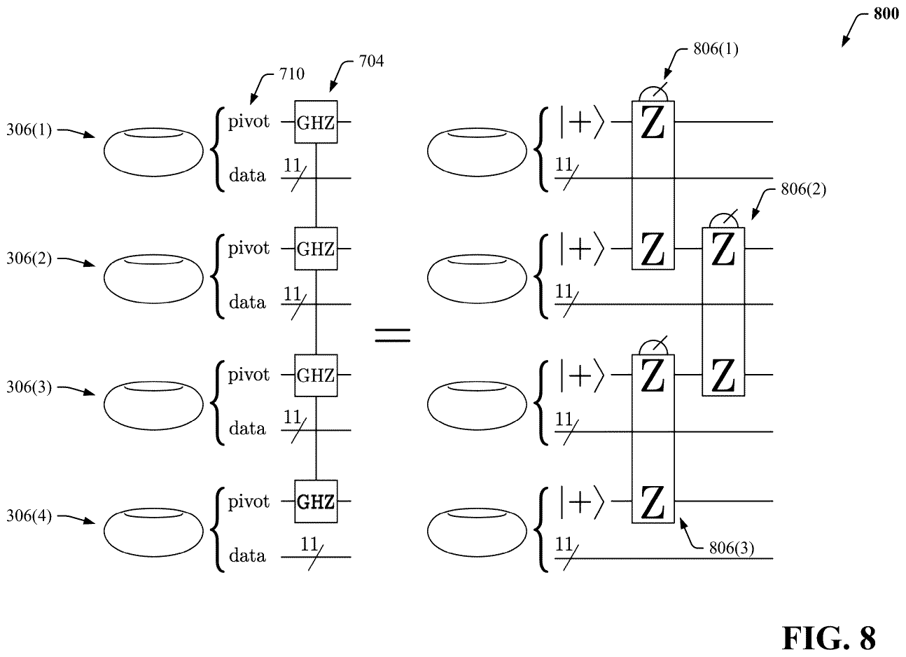

FIG. 8 illustrates an example, non-limiting diagram 800 showing GHZ state preparation across CIM modules in accordance with one or more embodiments described herein.

In various aspects, to implement the GHZ states 704 on the pivot qubits 710, operation component 202 can apply a sequence of ZZ-measurements 806. Specifically, operation component 202 can first apply a ZZ-measurement between even pairs of qubits followed by a ZZ-measurement between odd pairs of qubits, or vice versa. For example, operation component 202 can first apply a ZZ-measurement 806(1) between qubits of CIM module 306(1) and CIM module 306(2), and a ZZ-measurement 806(3) between qubits of CIM module 306(3) and CIM module 306(4). Thereafter, operation component 202 can apply a ZZ-measurement 806(2) between qubits of CIM module 306(2) and CIM module 306(3). Accordingly, the circuit depth is at most 2. In various aspects, the number of ZZ-measurements 806 equals the number of code blocks minus one. In any case, following GHZ state preparation on the pivot qubits 710, operation component 202 can perform the GHZ states on the universal adapter 310 connecting the one or more CIM modules 306.

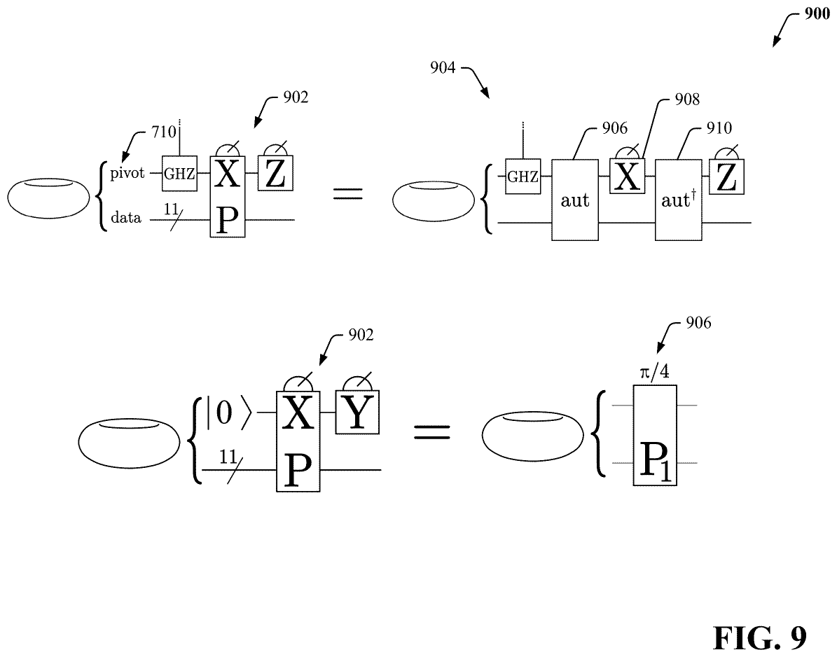

FIG. 9 illustrates an example, non-limiting diagram 900 showing how native Pauli measurements and native Pauli rotations can be implemented in accordance with one or more embodiments described herein.

In various embodiments, execution component 204 can perform native Pauli measurements. Specifically, operation component 202 can implement a set of native Pauli measurements 802 with the LPU 302 of CIM model 306 and by applying automorphisms, as shown by circuit 904 (as described with respect to FIG. 6).

To implement the set of native Pauli measurements 802 within a CIM module, operation component 202 can apply a measurement 908 on the pivot qubit 704 between an automorphism 906 and an automorphism 910. In various aspects, automorphism 910 can be a reverse of automorphism 906 (e.g., the same operation but in reverse). In other words, automorphism 910 can, in a sense, undo automorphism 906. In various embodiments, operation component 202 can implement different native Pauli rotations depending on the implementation of measurement 908, automorphism 906, and automorphism 910.

In various aspects, a set of native Cliford rotations 906 can be synthesized from the set of native Pauli measurements 902. In various embodiments, operation component 202 can synthesize the set of native Cliford rotations 906 from the set of native Pauli measurements 902 using only stabilizer operations. For example, as shown, a Pauli rotation at an angle of π/4 can be implemented with only stabilizer operations using the set of native Pauli measurements 902.

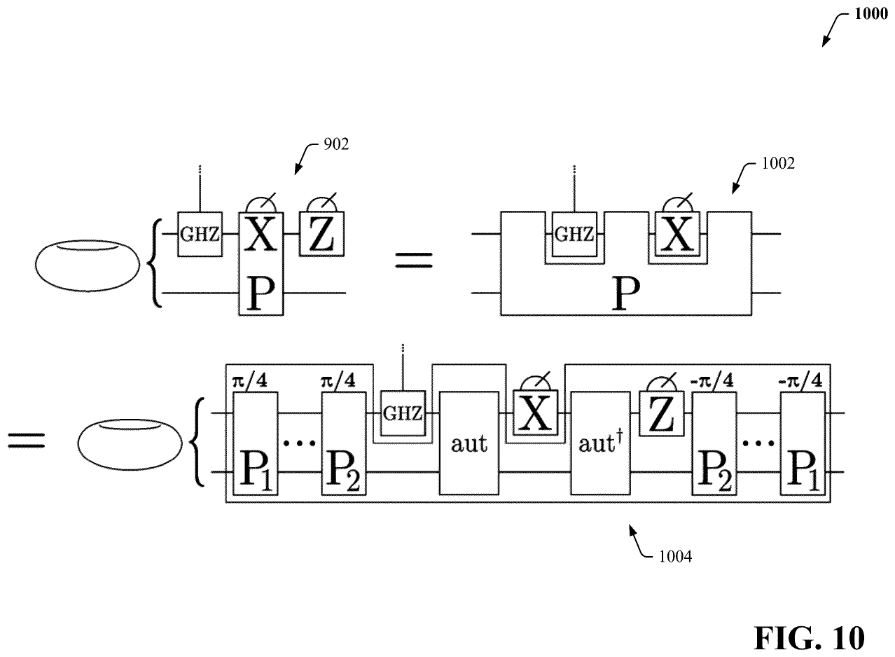

FIG. 10 illustrates an example, non-limiting diagram 1000 showing how general Pauli measurements can be implemented in accordance with one or more embodiments described herein.

In various embodiments, execution component 204 can perform general Pauli measurements using the set of native Pauli measurements 902. Specifically, operation component 202 can implement perform general Pauli measurements using circuit 1004. Circuit 1002 depicts an intermediate circuit used to synthesize circuit 1002 from the set of native Pauli measurements 902.

In various aspects, as shown, circuit 1004 can consist of native Pauli rotations and native Pauli measurements, which can be implemented using methods described with respect to FIGS. 7-9. In various instances, preparing a GHZ state and a Z-measurement can enable a Pauli rotation to be performed on a native Pauli measurement. Thereafter, to implement a general Pauli measurement, operation component 202 can apply native Pauli measurements between native Clifford rotations. This effectively multiplies Pauli matrices defining the native Pauli measurements by each other, which enables implementation of any general Pauli measurement.

Therefore, to implement a Pauli rotation can act on the entire quantum system 112, a native Pauli rotation that can act on one code block and get distributed across the quantum system 112 using the GHZ state.

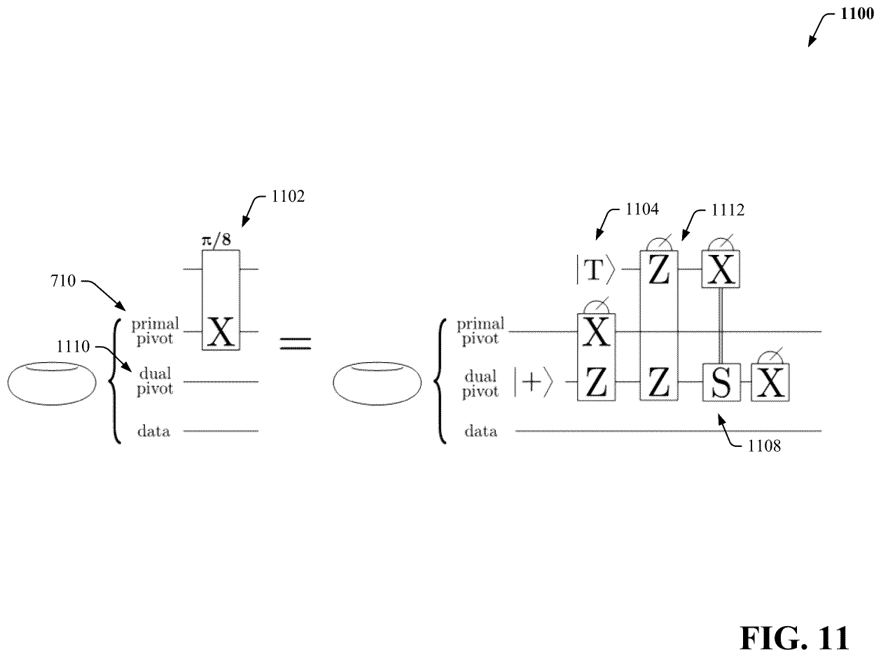

FIG. 11 illustrates an example, non-limiting diagram 1100 showing how small-angle rotations can be implemented in accordance with one or more embodiments described herein.

In various embodiments, operation component 202 can transform a magic state into a small-angle rotation 1102. For instance, a π/4 rotation can be applied by preparing a magic state 1104, such as a T-state, on an adjacent magic state factory module, which can then be injected. Thereafter, operation component 202 can apply measurements 1114.

In various instances, a correction 1108, such as an S-gate generated by the magic state factory module 308, can be applied based on the measurements 1114. In various aspects, the correction 1108 can be isolated on a dual pivot qubit 1112, thereby preventing the correction 1108 from applying to the rest of the circuit.

In various embodiments, operation component 202 can implement a small-angle rotation around any rotation axis. That is, operation component 202 can implement the small-angle rotation in the Z, X, or Y basis. In various aspects, operation component 202 can implement the small-angle rotation in the Z, X. or Y basis by adjusting the X⊗Z measurement on the pivot qubit 710 and dual pivot qubit 1110 to Z⊗Z, X⊗Z, or Y⊗Z respectively.

In various embodiments, operation component 202 can approximate any (smaller) angle rotation by repeated application of

$$\frac{π}{8} - Z$$

rotations, followed by

$$\frac{π}{8} - X$$

rotations, as shown in FIG. 11.

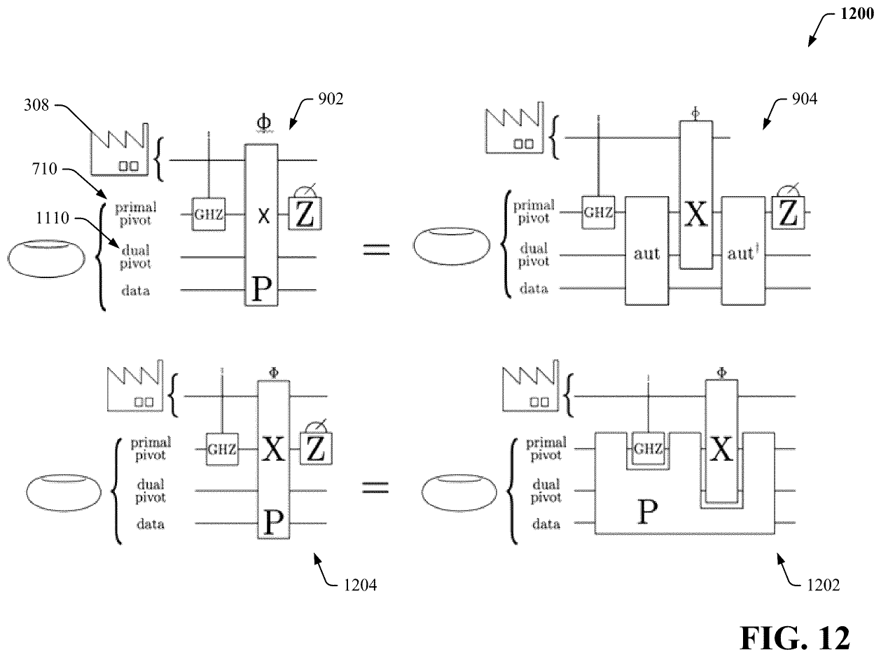

FIG. 12 illustrates an example, non-limiting diagram 1200 showing how non-Clifford phase rotations can be implemented in accordance with one or more embodiments described herein.

In various embodiments, execution component 204 can perform non-Clifford phase rotations. More generally, execution component 204 can apply φ−(X⊗P) Pauli rotations. In various instances, from a Pauli rotation, operation component 202 can implement non-Clifford phase rotations by applying circuit 804 if the Pauli rotation is native. That is, non-Clifford phase rotations can be implemented by applying a conjugation by automorphism (e.g., applying a first automorphism followed by a reverse of the automorphism). In other instances where the Pauli rotation is not native, as shown in circuit 1204 for example, operation component 202 can implement non-Clifford phase rotations by applying native Pauli rotations before and after preparing a GHZ state, as shown by circuit 1202.

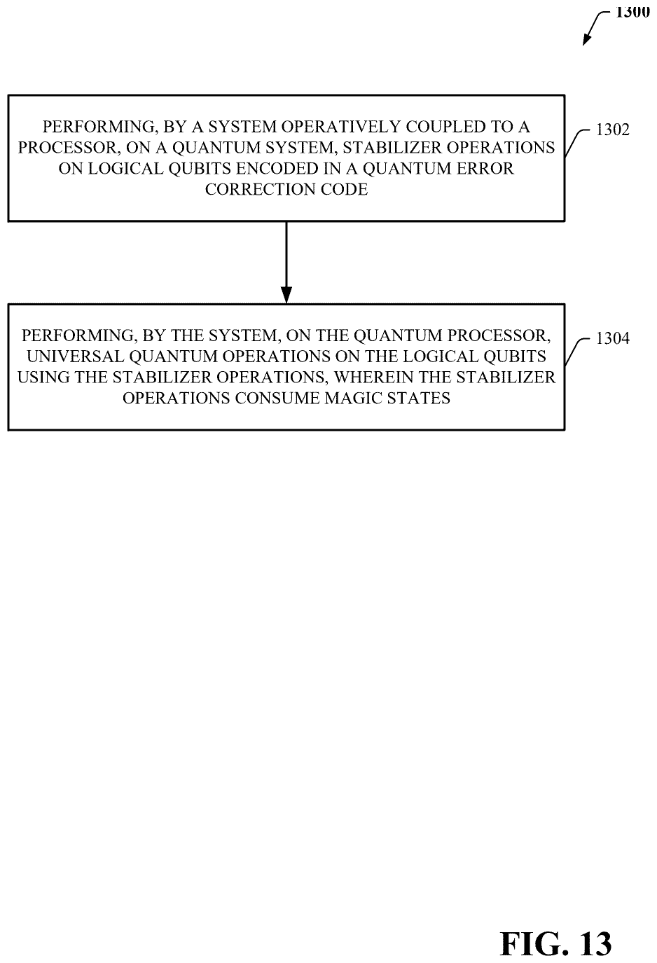

FIG. 13 illustrates a flow diagram of an example, non-limiting method 1300 that can facilitate CIM modular fault-tolerant quantum computing in accordance with one or more embodiments described herein. Repetitive description of like elements and/or processes employed in respective embodiments is omitted for sake of brevity.

At 1302, non-limiting method 1300 can comprise performing, by a system operatively coupled to a processor (e.g., by operation component 202), on a quantum processor (e.g., quantum processor 113), stabilizer operations on logical qubits encoded in a quantum error correction code (e.g., quantum error correction code 304).

At 1304, non-limiting method 1300 can comprise performing, by the system (e.g., by execution component 204), on a quantum processor, universal quantum operations on the logical qubits using the stabilizer operations, wherein the stabilizer operations consume magic states. In various aspects, the magic states can be generated by one or more magic state factory modules (e.g., magic state factory module 308).

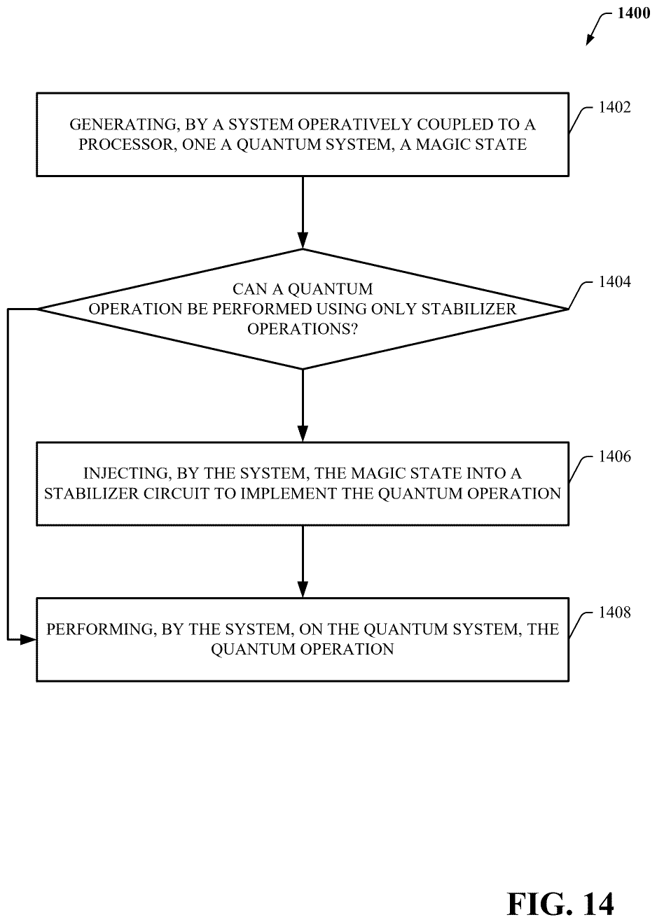

FIG. 14 illustrates a flow diagram of an example, non-limiting method 1400 that embodiments described herein. Repetitive description of like elements and/or processes employed in respective embodiments is omitted for sake of brevity.

At 1402, non-limiting method 1400 can comprise generating, by a system operatively coupled to a processor (e.g., by generation component 206), a magic state.

At 1404, non-limiting method 1400 can comprise determining whether a quantum operation can be performed using only stabilizer operations.

If no, then at 1406, non-limiting method 1400 can comprise injecting (e.g., by operation component 202), the magic state into a stabilizer circuit to implement the quantum operation.

If yes, then at 1408, non-limiting method 1400 can comprise performing (e.g., by execution component 204), on a quantum system (e.g., quantum system 112) the quantum operation.

FIG. 15 illustrates a block diagram of an example, non-limiting, operating environment 1500 in which one or more embodiments described herein can be facilitated. FIG. 15 and the following discussion are intended to provide a general description of a suitable operating environment 1500 in which one or more embodiments described herein at FIGS. 1-14 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1500 contains an example of an environment for the execution of at least some of the computer code involved in performing the inventive methods, such as modular fault-tolerant quantum computing architecture code 1528. In addition to block 1528, computing environment 1500 includes, for example, computer 1501, wide area network (WAN) 1502, end user device (EUD) 1503, remote server 1504, public cloud 1505, and private cloud 1506. In this embodiment, computer 1501 includes processor set 1510 (including processing circuitry 1520 and cache 1521), communication fabric 1511, volatile memory 1512, persistent storage 1514 (including operating system 1522 and block 1528, as identified above), peripheral device set 1514 (including user interface (UI) device set 1523, storage 1524, and Internet of Things (IoT) sensor set 1525), and network module 1515. Remote server 1504 includes remote database 1530. Public cloud 1505 includes gateway 1540, cloud orchestration module 1541, host physical machine set 1542, virtual machine set 1543, and container set 1544.

COMPUTER 1501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1530. As is well understood in the art of computer technology, and depending upon the technology, performance of a computer-implemented method may be distributed among multiple computers and/or between multiple locations. On the other hand, in this presentation of computing environment 1500, detailed discussion is focused on a single computer, specifically computer 1501, to keep the presentation as simple as possible. Computer 1501 may be located in a cloud, even though it is not shown in a cloud in FIG. 15. On the other hand, computer 1501 is not required to be in a cloud except to any extent as may be affirmatively indicated.

PROCESSOR SET 1510 includes one, or more, computer processors of any type now known or to be developed in the future. Processing circuitry 1520 may be distributed over multiple packages, for example, multiple, coordinated integrated circuit chips. Processing circuitry 1520 may implement multiple processor threads and/or multiple processor cores. Cache 1521 is memory that is located in the processor chip package(s) and is typically used for data or code that should be available for rapid access by the threads or cores running on processor set 1510. Cache memories are typically organized into multiple levels depending upon relative proximity to the processing circuitry. Alternatively, some, or all, of the cache for the processor set may be located “off chip.” In some computing environments, processor set 1510 may be designed for working with qubits and performing quantum computing.

Computer-readable program instructions are typically loaded onto computer 1501 to cause a series of operational steps to be performed by processor set 1510 of computer 1501 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1521 and the other storage media discussed below. The program instructions, and associated data, are accessed by processor set 1510 to control and direct performance of the inventive methods. In computing environment 1500, at least some of the instructions for performing the inventive methods may be stored in block 1528 in persistent storage 1514.

COMMUNICATION FABRIC 1511 is the signal conduction path that allows the various components of computer 1501 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1512 is any type of volatile memory now known or to be developed in the future. Examples include dynamic type random access memory (RAM) or static type RAM. Typically, volatile memory 1512 is characterized by random access, but this is not required unless affirmatively indicated. In computer 1501, the volatile memory 1512 is located in a single package and is internal to computer 1501, but, alternatively or additionally, the volatile memory may be distributed over multiple packages and/or located externally with respect to computer 1501.

PERSISTENT STORAGE 1514 is any form of non-volatile storage for computers that is now known or to be developed in the future. The non-volatility of this storage means that the stored data is maintained regardless of whether power is being supplied to computer 1501 and/or directly to persistent storage 1514. Persistent storage 1514 may be a read only memory (ROM), but typically at least a portion of the persistent storage allows writing of data, deletion of data and re-writing of data. Some familiar forms of persistent storage include magnetic disks and solid state storage devices. Operating system 1522 may take several forms, such as various known proprietary operating systems or open source Portable Operating System Interface-type operating systems that employ a kernel. The code included in block 1528 typically includes at least some of the computer code involved in performing the inventive methods.

PERIPHERAL DEVICE SET 1514 includes the set of peripheral devices of computer 1501. Data communication connections between the peripheral devices and the other components of computer 1501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1523 may include components such as a display screen, speaker, microphone, wearable devices (such as goggles and smart watches), keyboard, mouse, printer, touchpad, game controllers, and haptic devices. Storage 1524 is external storage, such as an external hard drive, or insertable storage, such as an SD card. Storage 1524 may be persistent and/or volatile. In some embodiments, storage 1524 may take the form of a quantum computing storage device for storing data in the form of qubits. In embodiments where computer 1501 is required to have a large amount of storage (for example, where computer 1501 locally stores and manages a large database) then this storage may be provided by peripheral storage devices designed for storing very large amounts of data, such as a storage area network (SAN) that is shared by multiple, geographically distributed computers. IoT sensor set 1525 is made up of sensors that can be used in Internet of Things applications. For example, one sensor may be a thermometer and another sensor may be a motion detector.

NETWORK MODULE 1515 is the collection of computer software, hardware, and firmware that allows computer 1501 to communicate with other computers through WAN 1502. Network module 1515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1515 are performed on the same physical hardware device. In other embodiments (for example, embodiments that utilize software-defined networking (SDN)), the control functions and the forwarding functions of network module 1515 are performed on physically separate devices, such that the control functions manage several different network hardware devices. Computer-readable program instructions for performing the inventive methods can typically be downloaded to computer 1501 from an external computer or external storage device through a network adapter card or network interface included in network module 1515.

WAN 1502 is any wide area network (for example, the internet) capable of communicating computer data over non-local distances by any technology for communicating computer data, now known or to be developed in the future. In some embodiments, the WAN 1502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1503 is any computer system that is used and controlled by an end user (for example, a customer of an enterprise that operates computer 1501), and may take any of the forms discussed above in connection with computer 1501. EUD 1503 typically receives helpful and useful data from the operations of computer 1501. For example, in a hypothetical case where computer 1501 is designed to provide a recommendation to an end user, this recommendation would typically be communicated from network module 1515 of computer 1501 through WAN 1502 to EUD 1503. In this way, EUD 1503 can display, or otherwise present, the recommendation to an end user. In some embodiments, EUD 1503 may be a client device, such as thin client, heavy client, mainframe computer, desktop computer and so on.

REMOTE SERVER 1504 is any computer system that serves at least some data and/or functionality to computer 1501. Remote server 1504 may be controlled and used by the same entity that operates computer 1501. Remote server 1504 represents the machine(s) that collect and store helpful and useful data for use by other computers, such as computer 1501. For example, in a hypothetical case where computer 1501 is designed and programmed to provide a recommendation based on historical data, then this historical data may be provided to computer 1501 from remote database 1530 of remote server 1504.

PUBLIC CLOUD 1505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1505 is performed by the computer hardware and/or software of cloud orchestration module 1541. The computing resources provided by public cloud 1505 are typically implemented by virtual computing environments that run on various computers making up the computers of host physical machine set 1542, which is the universe of physical computers in and/or available to public cloud 1505. The virtual computing environments (VCEs) typically take the form of virtual machines from virtual machine set 1543 and/or containers from container set 1544. It is understood that these VCEs may be stored as images and may be transferred among and between the various physical machine hosts, either as images or after instantiation of the VCE. Cloud orchestration module 1541 manages the transfer and storage of images, deploys new instantiations of VCEs and manages active instantiations of VCE deployments. Gateway 1540 is the collection of computer software, hardware, and firmware that allows public cloud 1505 to communicate through WAN 1502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1506 is similar to public cloud 1505, except that the computing resources are only available for use by a single enterprise. While private cloud 1506 is depicted as being in communication with WAN 1502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1505 and private cloud 1506 are both part of a larger hybrid cloud.

CLOUD COMPUTING SERVICES AND/OR MICROSERVICES (not separately shown in FIG. 15): private and public clouds 1506 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an operation component that performs, on a quantum processor, stabilizer operations on logical qubits encoded in a quantum error correction code; and
an execution component that performs, on the quantum processor, universal quantum operations on the logical qubits using the stabilizer operations, wherein the stabilizer operations consume magic states.

2. The system of claim 1, wherein the quantum error correction code is a high-rate quantum low-density parity-check (qLDPC) code.

3. The system of claim 1, wherein the operation component performs the stabilizer operations via one or more CIM (CIM) modules, and wherein the one or more CIM modules comprise a respective memory and a logical processing unit (LPU).

4. The system of claim 3, wherein the computer executable components further comprise:
a generation component that generates, via one or more magic state factory modules, the magic states using the quantum error correction code or a secondary quantum error correction code.

5. The system of claim 2, wherein the computer executable components further comprise:
a coupling component that couples the one or more CIM modules to each other.

6. The system of claim 5, wherein the coupling component couples the one or more CIM modules to the one or more magic state factory modules.

7. The system of claim 3, wherein the operation component allocates one or more pivot qubits in the respective memory of any of the one or more CIM modules.

8. The system of claim 5, wherein the coupling component connects the respective LPUs to each other through a set of bridge qubits and a set of bridge checks in the respective LPUs that are connected to the quantum error correction code.

9. The system of claim 1, wherein the operation component performs the stabilizer operations using generalized qLDPC surgery.

10. The system of claim 8, wherein Bell couplers create physical entangled states between physical qubits in the quantum processor to implement the set of bridge qubits and the set of bridge checks.

11. The system of claim 5, wherein the coupling component uses coupling between the one or more CIM modules to prepare Greenberger Horne Zeilinger (GHZ) states.

12. A computer-implemented method, comprising:
performing, by a system operatively coupled to a processor, on a quantum processor, stabilizer operations on logical qubits encoded in a quantum error correction code; and
performing, by the system, on the quantum processor, universal quantum operations on the logical qubits using the stabilizer operations, wherein the stabilizer operations consume magic states.

13. The computer-implemented method of claim 12, wherein the quantum error correction code is a high-rate quantum low-density parity-check (qLDPC) code.

14. The computer-implemented method of claim 12, further comprising:
performing, by the system, the stabilizer operations via one or more CIM (CIM) modules, and wherein the one or more CIM modules comprise a respective memory and a logical processing unit (LPU).

15. The computer-implemented method of claim 12, further comprising:
generating, by the system, via one or more magic state factory modules, the magic states using the quantum error correction code or a secondary quantum error correction code.

16. The computer-implemented method of claim 14, further comprising:
coupling, by the system, the one or more CIM modules to each other; and
coupling, by the system, the one or more CIM modules to the one or more magic state factory modules.

17. The computer-implemented method of claim 14, further comprising:
connecting, by the system, the respective LPUs to each other through a set of bridge qubits and a set of bridge checks in the respective LPUs that are connected to the quantum error correction code, wherein Bell couplers create physical entangled states between physical qubits in the quantum processor to implement the set of bridge qubits and the set of bridge checks.

18. The computer-implemented method of claim 14, further comprising:
utilizing, by the system, coupling between the one or more CIM modules to prepare Greenberger Horne Zeilinger (GHZ) states.

19. A computer program product facilitating a CIM modular fault-tolerant quantum computing architecture, the computer program product comprising a computer readable storage medium having program instructions embodied therewith, the program instructions executable by a processor to cause the processor to:
perform, by the processor, on a quantum processor, stabilizer operations on logical qubits encoded in a quantum error correction code; and
perform, by the processor, on the quantum processor, universal quantum operations on the logical qubits using the stabilizer operations, wherein the stabilizer operations consume magic states.

20. The computer program product of claim 19, wherein the program instructions executable by the processor further cause the processor to:
perform, by the processor, the stabilizer operations via one or more CIM (CIM) modules, and wherein the one or more CIM modules comprise a respective memory and a logical processing unit (LPU).
